(19) United States
(12) Patent Application Publication
(10) Pub. No.: US 2019/0092286 A1
(43) Pub. Date: Mar. 28, 2019

(54) CONTACTLESS CLEANING OF A SURFACE OF A VEHICLE

(71) Applicant: Ford Global Technologies, LLC, Dearborn, MI (US)

(72) Inventors: Oliver Henn, Euskirchen (DE); Martin Lichter, Erftstadt (DE); Heike Alberg, Roesrath (DE)

(73) Assignee: Ford Global Technologies, LLC, Dearborn, MI (US)

(21) Appl. No.: 16/034,594

(22) Filed: Jul. 13, 2018

(30) Foreign Application Priority Data
Sep. 26, 2017 (DE) 102017217090.5

(51) Int. Cl. B60S 1/52; B08B 3/02; B60S 1/54; B60S 1/58; B60S 1/56

(52) U.S. Cl. CPC B60S 1/522; B08B 3/024; B60S 1/56; B60S 1/58; B60S 1/544

(57) ABSTRACT

A method is disclosed for cleaning a surface of a vehicle which comprises a holder connected to the vehicle, wherein the holder comprises at least one nozzle. Within the scope of the method, a cleaning agent is applied at a pressure above atmospheric pressure by the at least one nozzle onto the surface to be cleaned, wherein the at least one nozzle is moved in a contactless manner over the surface.

### FIELD OF THE INVENTION

The present invention generally relates surface cleaning, and more particularly relates to a device and method for cleaning a surface of a vehicle, such as a windshield or a mirror of a motor vehicle.

### BACKGROUND OF THE INVENTION

Window panes, in particular windshields of wheeled motor vehicles or other vehicles, are typically cleaned with the use by windshield wipers that wipe the surface with contact. However, there is the risk that by the wiping process scratches are produced on the surface, in particular when the window pane to be cleaned consists of a different material from glass. Damage to the surface to be cleaned may be caused, on the one hand, by contact of the windshield wiper, in particular a wiper blade, with the surface or by dirt located on the surface being rubbed over the surface by the wiping process.

With regard to the effectiveness of the cleaning, the wiping process is also dependent on the geometric conditions between the wiper blade and the window pane and/or the surface to be cleaned. In this case, in particular, the shape of the surface to be cleaned and the shape of the wiper blade are important. For satisfactory cleaning, therefore, the surface to be cleaned should have only a limited curvature. If, therefore, specific geometric boundary conditions are not maintained, the quality of the wiping and/or cleaning process may potentially be impaired.

The material of the wiper blade is additionally subjected to wear and tear, as well as material fatigue and damage which may occur over time and according to the environmental conditions. This also reduces the cleaning quality over the course of time. In winter, moreover, there is the risk that the wiper blade freezes solid onto the window pane and is potentially damaged if it is not carefully removed from the window pane. Moreover, a satisfactory cleaning result generally may only be achieved in regions of the surface where the wiper blade is directly in contact with the surface to be cleaned and, in particular, exerts a specific pressure on the surface during the cleaning process.

A system for cleaning the surface of windshields and further surfaces is disclosed in the document WO 2016/177380 A1. This system dispenses with windshield wipers and instead conducting compressed air via nozzles onto the surface to be cleaned, wherein the respective surface is cleaned in this manner.

It would be desirable to provide an advantageous method for cleaning a surface of a vehicle and an advantageous device for cleaning a surface of a vehicle particularly, a motor vehicle, wherein in particular the drawbacks described above of the windshield wiper units used hitherto are remedied.

### SUMMARY OF THE INVENTION

According to one aspect of the present invention, a method for cleaning a surface of a vehicle is provided. The method includes the steps of applying a cleaning agent at a pressure above atmospheric pressure onto the surface to be cleaned with at least one nozzle of a holder connected to the vehicle, and moving the at least one nozzle in a contactless manner over the surface.

According to another aspect of the present invention, a device for cleaning a surface of a vehicle is provided. The device for cleaning a surface of the vehicle includes a holder connected to the vehicle, and at least one nozzle of the holder that is movable in a contactless manner over the surface and designed to apply a cleaning agent at a pressure above atmospheric pressure onto the surface to be cleaned.

According to a further aspect of the present invention, a motor vehicle is provided. The motor vehicle includes a surface, a holder connected to the vehicle, and at least one nozzle of the holder that is movable in a contactless manner over the surface and designed to apply a cleaning agent at a pressure above atmospheric pressure onto the surface to be cleaned.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of a part of a motor vehicle with a cleaning device, according to one embodiment;

FIG. 2 is a perspective view of a part of a motor vehicle with a variant of a cleaning device, according to another embodiment;

FIG. 3 is a perspective view of a part of a motor vehicle with a further variant of a cleaning device, according to a further embodiment;

FIG. 4 is a perspective view of a part of a motor vehicle with a further variant of a cleaning device, according to yet another embodiment; and

FIG. 5 is a perspective view of a part of a motor vehicle with a further variant of a cleaning device, according to a further embodiment.

### DETAILED DESCRIPTION OF THE PREFERRED EMBODIMENTS

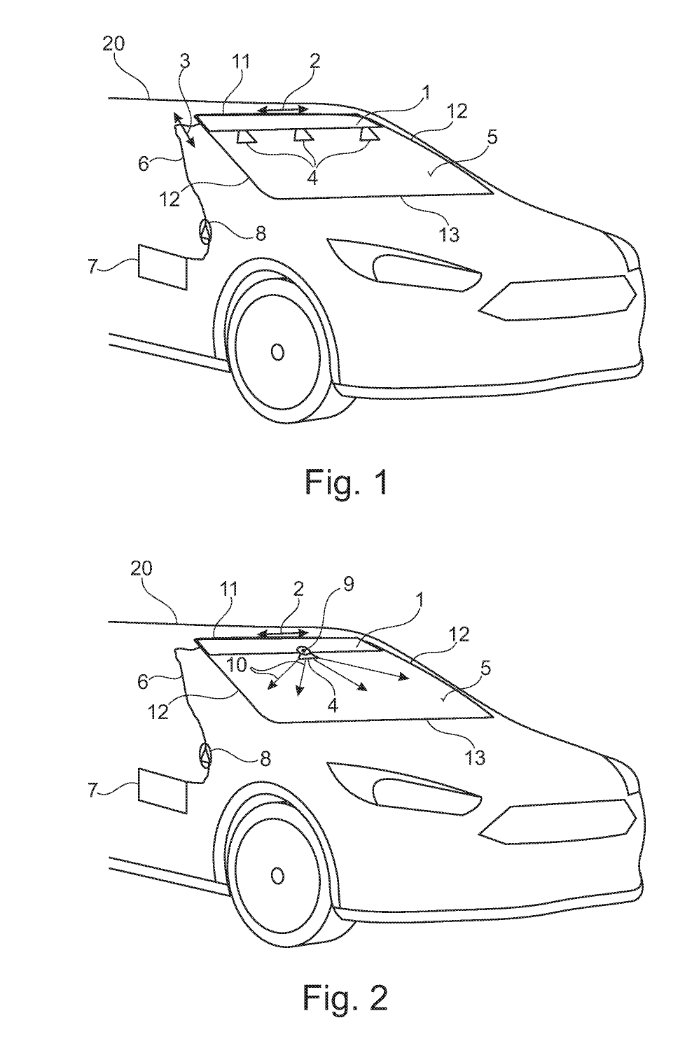

The present device and method are described by way of example in more detail hereinafter with reference to FIGS. 1-5. FIGS. 1-5 show in each case a part of a motor vehicle schematically in a perspective view. Elements which correspond to one another are provided in each case with the same reference numerals. In each case, the motor vehicle 20 is shown with a windshield 5 as the surface to be cleaned. The windshield in each case comprises an upper edge 11, a lower edge 13 and two side edges 12. The motor vehicle may, for example, be a passenger motor vehicle.

The device according to one embodiment comprises in each case at least one holder 1 with a number of nozzles 4. The holder 1 is connected to the motor vehicle 20, for example, fixedly or releasably connected. The number of nozzles 4 is connected via a hose connection 6 to a compressor and/or pressure generator 8. By use of the compressor 8, a cleaning agent may be subjected to pressure and this cleaning agent may be applied onto the surface 5 to be cleaned via at least one nozzle 4. The device according to the disclosed embodiment is designed such that the at least one nozzle 4 may be moved in a contactless manner over the surface 5.

In one advantageous variant, at least one tank 7 is provided for storing a liquid cleaning agent, for example, water and/or antifreeze mixture and/or glass cleaning agent. In this variant, the tank 7 is connected by flow technology to the compressor 8 via a hose connection 6. As a result, the cleaning agent stored in the tank 7 may be subjected to pressure and applied to the surface 5 to be cleaned via the nozzles 4 at a pressure above atmospheric pressure.

In FIG. 1, the holder 1 is arranged on the upper edge 11 of the windshield 5. By way of example, three nozzles 4 are provided on the holder 1. These nozzles 4 may be moved in the direction identified by an arrow with the reference numeral 2 in a horizontal direction along the holder 1. Additionally, in the embodiment shown in FIG. 1, the entire holder 1 may be moved over the surface 5 in the direction identified by the reference numeral 3. By the movement of the holder 1 in the direction 3, in particular in the manner of an upward and downward movement, and the simultaneous movement of the nozzles 4 in the direction 2 over the surface 5, the entire windshield is completely cleaned. The movement of the holder 1 and/or the nozzles 4 may be adapted to the respective situation. The movement of the holder 1 and the movement of the nozzles 4 may also be carried out in a fixed sequence simultaneously or in succession.

In FIG. 2, the holder 1 is arranged on the upper edge 11 of the windshield 5. In the embodiment shown, only one nozzle 4 is provided. This nozzle 4 may be moved along the holder 1 in the direction 2. Additionally or alternatively, the nozzle 4 may perform a rotational movement about the axis 9. By the rotational movement, the cleaning agent may be applied in different directions 10 onto the surface 5. Also in this embodiment an efficient and complete cleaning of the surface is achieved. Since only the nozzle is moved but not additionally the holder, the driver is diverted or distracted only minimally by the cleaning process.

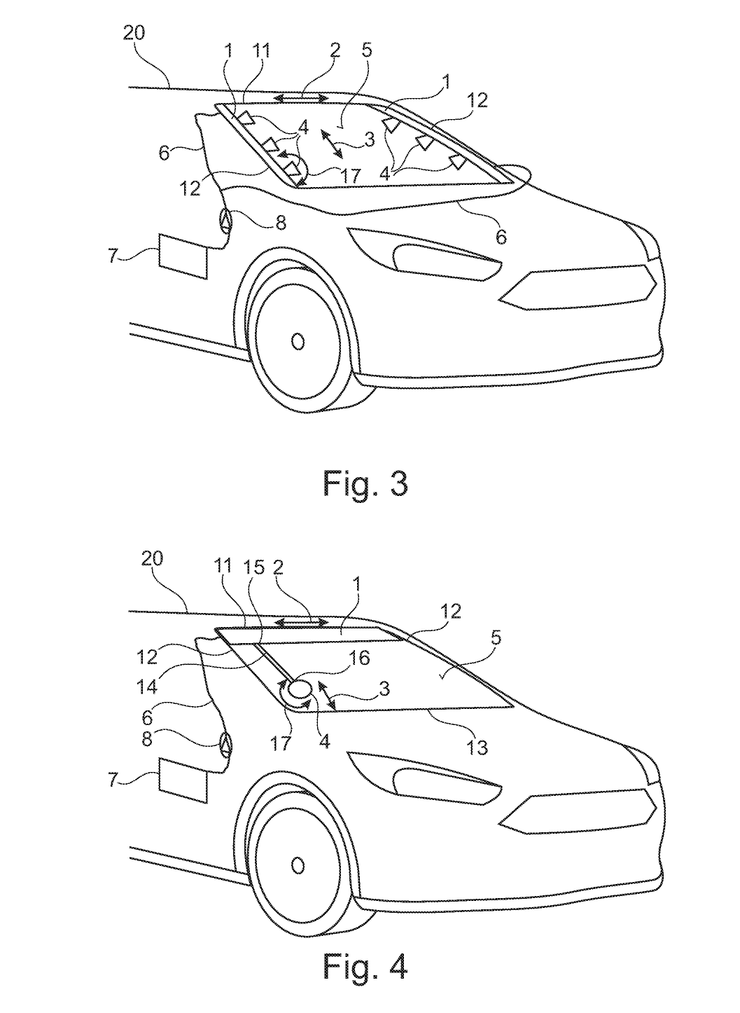

While in FIGS. 1 and 2 the holder 1 is arranged in each case on the upper edge 11 of the windshield 5, in the embodiment shown in FIG. 3, two holders 1 are provided. The holders 1 are arranged in each embodiment on the side edges 12 of the windshield 5. Each of the holders 1 comprises at least one nozzle 4 and in one exemplary embodiment, three nozzles. The nozzles 4 are designed to apply a cleaning agent onto the windshield 5 at the side.

In the embodiment shown in FIG. 3, the holders 1 may be fastened fixedly to the motor vehicle 20 or may be designed to be moved in the direction 2 over the surface 5. Additionally or alternatively, the nozzles 4 may be designed in order to be moved in the direction 3 along the respective holder 1. Additionally or alternatively, the nozzles 4 may be designed, for example as in the embodiment shown in FIG. 2, to be rotated about an axis and/or to perform a rotational movement during the cleaning process. The rotational axis may extend perpendicular to the surface 5 at a position below the respective nozzle 4. The rotational movement of a nozzle 4 is identified by way of example by an arrow 17. The embodiment shown in FIG. 3 also permits an efficient cleaning of the entire surface 5 with minimal impairment to the field of view of the driver.

In the embodiment shown in FIG. 4, as in the embodiments shown in FIGS. 1 and 2, a holder 1 is arranged on the upper edge 11 of the windshield 5. The holder 1 in this embodiment is fixedly arranged there and thus is not movable relative to the windshield 5. In the embodiment shown in FIG. 4, a holder arm 14 is provided, the holder arm 14 being connected at a first end 15 to the holder 1 and having a nozzle 4 at a second end 16. The holder arm 14 is designed such that it is movable in the direction 2 along the holder 1. Moreover, the nozzle 4 is arranged on the holder arm such that it may be moved along the holder arm 14, in the direction 3. The nozzle 4 may additionally be designed such that it may perform a rotational movement, identified by an arrow 17, about an axis extending perpendicular to the surface 5 to be cleaned. As a result, in the embodiment shown in FIG. 4, the nozzle 4 may be moved via the holder arm 14 in the direction 2 and 3 over the entire surface 5. Thus, the entire surface 5 may be efficiently cleaned in a contactless manner.

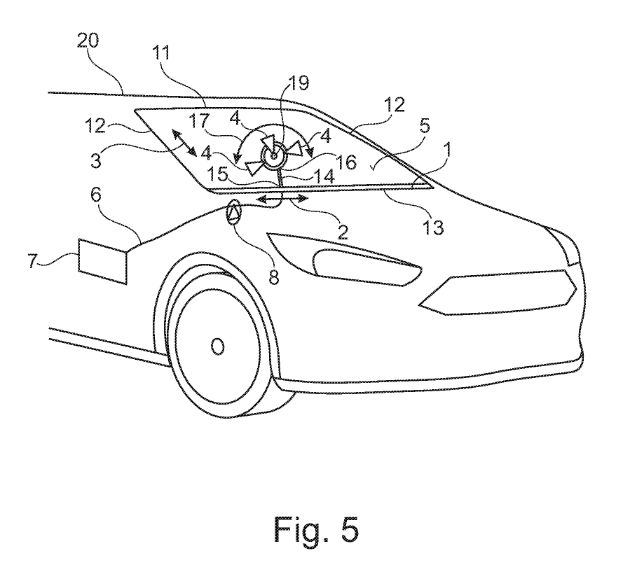

In the embodiment shown in FIG. 5, the holder 1 is arranged on the lower edge 13 of the windshield 5. As in the embodiment shown in FIG. 4, a holder arm 14 is provided, the holder arm 14 being able to be moved in the direction 2 on the holder 1 over the surface 5. The holder arm 14 is arranged at the first end 15 on the holder 1 and movably fastened thereto. An annular holder element 18 is arranged at the second end 16 of the holder arm 14 on which a number of nozzles 4 are located. The nozzles 4 are arranged on the annular holder element 18 and optionally fastened such that they are able to perform a rotational movement along the annular holder element, for example a rotational movement about a central axis 19 of the holder element 18 extending perpendicular to the surface. This is identified by an arrow with the reference numeral 17. Also in this embodiment, a maximum cleaning action is achieved with a small number of nozzles as is also the case in the embodiment shown in FIG. 4.

In principle, in each case all of the nozzles 4 provided may be supplied with the same cleaning agent. The cleaning agent may be changed or varied depending on the situation and desired application. Alternatively, separate nozzles 4 may be provided for each cleaning agent, for example, a number of nozzles 4 for the application of compressed air and a number of nozzles 4 for the application of one or more liquid cleaning agents.

The method according to one embodiment for cleaning a surface of a vehicle relates to a vehicle which comprises at least one holder connected to the vehicle. In this case, the holder is preferably permanently connected to the vehicle. The holder comprises at least one nozzle. Within the scope of the method, a cleaning agent is applied at a pressure above atmospheric pressure (1 bar) by use of the at least one nozzle onto the surface to be cleaned. In this case, the at least one nozzle is moved in a contactless manner over the surface to be cleaned.

Within the scope of the present disclosure, the atmospheric pressure is regarded as a pressure of 1 bar and/or 101.325 kPa. The cleaning agent may, for example, be applied at a pressure of between 1 bar and 5 bar onto the surface to be cleaned.

The method according to the disclosure has the advantage that it permits a contactless cleaning of the surface and as a result damage to the surface, which is caused by the contact with windshield wiper blades or by the particles of dirt located on the surface being pushed over the surface, is avoided. Since, in principle, contact of the cleaning device with the surface is also dispensed with, effective cleaning may be achievable even in regions where there is no contact. In other words, regions which are usually located outside the range of the windshield wiper unit and/or the windshield wiper blades used may also be successfully cleaned.

The at least one holder and/or the at least one nozzle may be moved in the form of a translation and/or a rotation. It is, therefore, possible, on the one hand, that the entire holder is moved with the nozzle(s) arranged thereon over the surface to be cleaned or the at least one or more nozzles are moved along one or more holders during the cleaning process. In this connection, numerous options are able to be implemented for these movements. These movements may be provided and designed so as to be adapted to the shape and the size of the surface to be cleaned, for example of the windshield, the headlamp surface or a mirror to be cleaned. In particular by a corresponding design of the holder, the number and arrangement of the nozzles and the movement of the holder and/or the nozzles may also achieve an efficient cleaning of highly curved surfaces.

In principle, a gaseous and/or a liquid cleaning agent may be used. Preferably for drying window panes in the case of rain or for removing snow or particles of dirt applied to the window pane, in particular, compressed air may be used for the cleaning. In the case of ice located on the surface or dirt adhering to the surface, water or a screen wash and/or an antifreeze mixture comprising liquid cleaning agent may be used. A combination adapted to the respective situation is also possible. Therefore, in other words, air and/or water and/or an antifreeze mixture and/or a glass cleaning agent may be used as the cleaning agent. These may be applied individually or a plurality thereof may be applied at the same time and/or at fixed times or depending on fixed conditions, for example weather conditions or the type and degree of soiling.

In one advantageous embodiment, the cleaning agent used is applied in a pulsed manner such that it is sprayed at a variable pressure onto the surface to be cleaned. In this embodiment, the pressure used may be regularly varied and may be adjustable in its maximum and minimum strength. In this manner, an efficient cleaning of the surface adapted to the respective cleaning situation is achieved.

The holder and/or the at least one nozzle are preferably moved over the surface at a fixed and/or defined distance from the surface. In this case, the fixed distance may be between a lower limit value and an upper limit value, so that a specific variation is permitted during the movement over the surface. The distance, however, may also be kept constant at a fixed value even during the movement over the surface. This has the advantage that a uniform cleaning result is achieved over the entire surface. The tolerance of certain deviations in the distance between a lower threshold value and an upper threshold value has the advantage that alterations to the shape of the surface, in particular curvatures or edges, may be taken into account during the movement of the nozzle over the surface without, for example, the nozzle itself having to be moved along the edge.

The holder and/or the at least one nozzle are preferably moved on a fixed trajectory over the surface. This has the advantage that similar to conventionally used windshield wipers the driver may become accustomed to the movement sequence and not be diverted or distracted thereby. Moreover, the holder and/or the at least one nozzle may be moved at a fixed and/or defined speed over the surface. The holder and/or the at least one nozzle may preferably be moved repeatedly and/or multiple times over the surface. The speed and/or the number of repetitions may be adapted to the situation which is present in each case, in particular the weather conditions or the degree of soiling. The movement may be carried out, for example, repeatedly at a fixed speed.

The device according to one embodiment for cleaning a surface of a vehicle comprises at least one holder connected to the vehicle. In this embodiment, the holder may be fixedly connected to the vehicle, or permanently connected to the vehicle such that the holder is movable along a surface of the vehicle relative to the vehicle.

The holder comprises at least one nozzle, preferably a number of nozzles. The at least one nozzle is movable in a contactless manner over the surface and is designed to apply a cleaning agent at a pressure above atmospheric pressure onto the surface to be cleaned. In principle, the nozzle may be fixedly connected to the holder or movable along the holder. Thus in each case only the nozzle and the holder with the nozzle, or the holder and the nozzle, may be movable over the surface to be cleaned.

Preferably, the device is designed such that a cleaning agent is applied to the surface, while at the same time the nozzle is moved in a contactless manner over the surface. Advantageously, the at least one holder and/or the at least one nozzle is designed to perform a movement in the form of a translation and/or a rotation.

In an exemplary embodiment, the holder comprises a holder arm. The holder arm may comprise a first end and a second end. The holder arm may be arranged at the first end on the holder. At least one nozzle or at least one holder element, on which a number of nozzles are arranged, may be arranged at the second end. The holder element may be designed in order to carry out a rotational movement of the nozzles. The holder element may be of annular design. The holder element may be fastened to the holder arm or displaceably arranged on the holder arm for performing a translatory movement along the holder arm.

The device according to the disclosed embodiment has, in principle, the same properties and advantages as the method described above. It is designed, in particular, to carry out a method according to the embodiment described above. By the contactless cleaning of the surface, for example a windshield, a mirror, a headlamp or a rear windshield, damage to the surface due to a conventional wiping process may be avoided. In particular, in the case of plastics material, scratching is efficiently prevented. At the same time, a high quality cleaning result is achieved.

The device according to one embodiment may comprise a compressor and/or pressure generator connected by flow technology to the at least one nozzle, for subjecting the cleaning agent to a pressure above atmospheric pressure, for example for subjecting the cleaning agent to a pressure of between 1 bar and 5 bar. In principle, according to one embodiment, a pressure of the cleaning agent of up to 5 bar or higher is suitable.

Additionally or alternatively, the device may comprise at least one tank connected by flow technology to the at least one nozzle, for saving and/or storing a cleaning agent. Preferably, a plurality of tanks are provided for storing different cleaning agents. One of the tanks may be filled, for example, with water or may be designed to be filled with water. A further tank may be filled with antifreeze mixture or a solution comprising antifreeze mixture or may be designed to be filled with the antifreeze mixture. A further tank or an alternatively provided tank may be designed to be filled with a glass cleaner or a solution comprising a glass cleaner or filled therewith. The number of tanks provided and the filling of the tanks may be set individually. The provision of a plurality of tanks has the advantage that different cleaning agents may be provided at the same time or in quick succession one after the other and the cleaning process may be optimized in this manner.

The surface to be cleaned may, in principle, comprise a reflective surface and/or a mirror surface or an at least partially transparent surface. For example, the surface to be cleaned may be a windshield, a rear windshield, a mirror surface, a surface of a headlamp or a further illumination device. The surface to be cleaned may also be part of a windshield or part of a rear windshield or part of an illumination device, such as for example a headlamp or indicator or part of a side mirror.

In principle, in connection with the method or the device according to the disclosed embodiment, the vehicle may be a motor vehicle, for example a passenger motor vehicle, a truck, a motorcycle, or a ship or an aircraft. In principle, the method and device are suitable for providing an alternative cleaning option for applications in which windshield wipers are conventionally used.

The motor vehicle comprises a device according to the disclosure described above. The motor vehicle designed to carry out a method according to the disclosure described above. The motor vehicle according to one embodiment has, in principle, the same properties and advantages as the device and method according to the disclosure described above.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A method for cleaning a surface of a vehicle comprising:
applying a cleaning agent at a pressure above atmospheric pressure onto the surface to be cleaned with at least one nozzle of a holder connected to the vehicle; and
moving the at least one nozzle in a contactless manner over the surface.

2. The method as claimed in claim 1, wherein the holder and the at least one nozzle is moved in the form of at least one of a translation and a rotation.

3. The method as claimed in claim 2, wherein both the holder and the at least one nozzle are moved.

4. The method as claimed in claim 1, wherein the cleaning agent comprises at least one of a gaseous and a liquid cleaning agent.

5. The method as claimed in claim 4, wherein the cleaning agent comprises at least one of air, water, an antifreeze mixture and a glass cleaning agent.

6. The method as claimed in claim 1, wherein the step of applying the cleaning agent comprises applying the cleaning agent is applied in a pulsed manner.

7. The method as claimed in claim 1, wherein the at least one nozzle is moved over the surface at a fixed distance from the surface.

8. The method as claimed in claim 1, wherein the at least one nozzle is moved on a fixed trajectory over the surface.

9. The method as claimed in claim 1, wherein the at least one nozzle is moved at a fixed speed over the surface.

10. The method as claimed in claim 1, wherein the at least one nozzle is moved repeatedly over the surface.

11. The method as claimed in claim 1, wherein the surface to be cleaned comprises at least one of a mirror surface and an at least partially transparent surface.

12. The method as claimed in claim 11, wherein the surface to be cleaned one of a windshield, a rear windshield, an illumination device, and a side mirror.

13. A device for cleaning a surface of a vehicle, comprising:
a holder connected to the vehicle; and
at least one nozzle of the holder that is movable in a contactless manner over the surface and designed to apply a cleaning agent at a pressure above atmospheric pressure onto the surface to be cleaned.

14. The device as claimed in claim 13, wherein the at least one nozzle is designed to perform a movement in the form of at least one of a translation and a rotation.

15. The device as claimed in claim 13, wherein the device further comprises a pressure generator connected by flow technology to the at least one nozzle for subjecting the cleaning agent to a pressure above atmospheric pressure and/or at least one tank connected by flow technology to the at least one nozzle for storing the cleaning agent.

16. The device as claimed in claim 13, wherein the holder comprises a holder arm which comprises a first end and a second end, wherein the holder arm is arranged at the first end on the holder and at least one nozzle is arranged at the second end.

17. The device as claimed in claim 13, wherein the surface to be cleaned comprises one of a mirror surface and an at least partially transparent surface.

18. The device as claimed in claim 17, wherein the surface to be cleaned is one of a windshield, a rear windshield, an illumination device, and a side mirror.

19. A motor vehicle comprising:
a surface;
a holder connected to the vehicle; and
at least one nozzle of the holder that is movable in a contactless manner over the surface and designed to apply a cleaning agent at a pressure above atmospheric pressure onto the surface to be cleaned.

20. The motor vehicle as claimed in claim 19, wherein the surface to be cleaned is one of a windshield, a rear windshield, an illumination device, and a side mirror.
